(19) United States
(12) Patent Application Publication
(10) Pub. No.: US 2018/0046731 A1
(43) Pub. Date: Feb. 15, 2018

(54) METHOD AND SYSTEM FOR EDITING A BROWSING SESSION

(71) Applicant: CROOSING LTD, Beer Sheva (IL)

(72) Inventors: Yaron PERETZ, Meitar (IL); Uri RAVIN, Hod Hasharon (IL)

(73) Assignee: CROOSING LTD, Beer Sheva (IL)

(21) Appl. No.: 15/558,135

(22) PCT Filed: Mar. 24, 2016
(86) PCT No.: PCT/IL2016/050317

§ 371 Date: Sep. 13, 2017

(30) Foreign Application Priority Data
Mar. 26, 2015 (IL) 237986

(51) Int. Cl. G06F 17/30; G06F 17/22

(52) U.S. Cl. CPC G06F 17/30905; G06F 17/30896; G06F 17/30873; G06F 17/2247; G06F 17/24

(57) ABSTRACT

A computer-implemented method for editing a browsing session includes adding, editing, cutting or changing actions in recorded browsing sessions. The method enables adding at least one layer of content to an original browsing session either during the recording of the browsing session (i.e., in real-time while recording) or (at any time) after completing the recording of the browsing session, by injecting scripts to a webpage being displayed. The layers of content that were added to an original browsing session are edited, cut or changed.

### FIELD OF THE INVENTION

The present invention relates to the field of information sharing over networks such as the internet. More particularly, the invention relates to a method and system for streaming web browsing information.

### BACKGROUND OF THE INVENTION

Although nowadays more users are connected to the Internet and conduct their daily activities electronically, such as reading news or consuming information by using a web browser, most users usually visits only a limited number of websites (actually they usually return to the same websites on a daily basis). As the internet includes a tremendous amount of websites, the average user misses most of them, fails to explore new websites and eventually returns to the same website he/she already knows. Therefore, there is a need to provide a novel service that will help users to be introduced to new websites and discover new content. Such a novel service refers herein as a broadcasting technology for web browsing via a web browser.

Moreover, today, content creators are chained to old school methods of storytelling, like texts, images and videos. They can embed links and direct their followers to one online destination or another—but can't lead them in a journey through several content points. The internet became public at the 1990s, but the available types of media (texts, images, videos) are the same as the ones used decades and centuries before it.

It is an object of the present invention to provide a native online oriented medium that allows creating and/or enjoying a voyage online, and by that it uniquely leverages the real possibilities of online storytelling and helps users to curate new content sources.

It is another object of the present invention to provide a system which is capable of broadcasting web browsing sessions, live or on-demand, creating the first synthesis between concepts of broadcasting and browsing.

It is yet another object of the present invention to provide a system which is capable of adding content layers while recording a browsing session, thereby by enabling broadcasting content from the web with commentary, soundtrack, marking and other personal additions.

Other objects and advantages of the invention will become apparent as the description proceeds.

### SUMMARY OF THE INVENTION

The present invention relates to a computer-implemented method for broadcasting browsing sessions comprising the steps of: providing a web browser adapted for recording of browsing actions taken while using said web browser and enabling to add layers of content during the recording and saving the recorded actions as a unique recorded session in a database, and whenever requesting to activate said stored unique recorded session, fetching said stored browsing actions and executing each action using a web browser adapted for recreation of said recorded actions either live or on demand, thus the recorded actions are executed all over again while viewing.

According to an embodiment of the present invention, the recording and the adding of layers is done by a recording extension (herein a record/edit plug-in manager) installed or added to the web browser, wherein said recording extension adapted to manage one or more plug-ins and to inject one or more of said plug-ins into a HTML currently displayed by said web browser.

According to an embodiment of the invention, the plug-ins are JavaScript (JS) plug-ins.

According to an embodiment of the invention, the method further comprises enabling to edit the recorded sessions by allowing adding, cutting or changing actions and layers in said recorded sessions.

According to an embodiment of the invention, the added layer of content can be audible data, visual data, textual data or combination thereof.

According to an embodiment of the invention, the layers adding/editing is obtained by providing to the browser HTML and JavaScript (JS) adapted for adding layers.

According to an embodiment of the invention, the method further comprises enabling filtering affiliate ID included in URL addresses.

According to an embodiment of the invention, the method further comprises enabling replacing the filtered affiliate ID with an alternative affiliate ID and share revenue accordingly.

In another aspect, the present invention relates to a computer-implemented method for recording a browsing session. The method comprising the steps of:
a) Receiving data generated by at least one input device during said browsing session, wherein said received generated data is relative to each individual action applied by said at least one input device in accordance with each specific visited webpage during said browsing session;
b) Converting the received generated data with respect to each individual action into a textual format, such that the individual actions applied with respect to each specific visited webpage forms a unique recorded browsing session; and
c) Storing said converted data as a unique recorded browsing session in a database, such that the unique recorded browsing session can be recreated or reproduced, e.g., either in-live or on-demand all over again by a web browser or other player.

According to an embodiment of the invention, the recording of the browsing session is done by a web browser that is adapted for recording of browsing actions applied by the at least one input device.

According to an embodiment of the invention, the recording is done by a recording extension (herein a record plug-in manager) installed or added to the web browser, wherein said recording extension is adapted to manage one or more plug-ins and to inject one or more of said plug-ins into a webpage currently displayed by said web browser.

According to an embodiment of the invention, the method further comprising reducing the amount of the received generated data, so that the data relative to an action applied by the at least one input device can be optimized.

In another aspect, the present invention relates to a computer-implemented method for playing a browsing session via a web browser. The method comprising the steps of: a) fetching, from a database, data relative to actions applied via a web browser during a browsing session, wherein said actions are performed with at least one input device during the browsing session and in correspondence with one or more visited webpages; b) executing each fetched action with respect to the corresponding webpage by using a web browser adapted for recreation of said applied actions either live or on demand, such that the browsing session can be executed all over again.

In still another aspect, the present invention relates to a computer-implemented method for editing a browsing session. The method comprising providing enabling to add at least one layer of content to an original browsing session either during the recording of the browsing session (i.e., in real-time while recording) or (at any time) after completing the recording of the browsing session, by injecting scripts to a webpage being displayed.

According to an embodiment of the invention, the editing includes fetching, from a database, data relative to actions applied by at least one input device during the recording of an original browsing session; and ability to add at least one layer of content to the original browsing session either during the recording of the browsing session or after completing the recording of the browsing session, by injecting scripts to a webpage being displayed, thereby enabling to change or to enrich the content of the original recorded browsing session

According to an embodiment of the present invention, in which the editing further comprises adding, cutting or changing actions and added content layers in recorded browsing sessions.

According to an embodiment of the present invention, the content may include audible data (e.g., soundtrack), visual data (e.g., text, symbols, captions, marks, emoticons, etc.), combination thereof, or any other form of data suitable to enrich the original recorded browsing session.

According to an embodiment of the present invention, the editing is done by an extension installed or added to a web browser, wherein said extension adapted to manage one or more plug-ins and to inject one or more of said plug-ins into a webpage currently being displayed.

According to an embodiment of the present invention, the editing is done by a designated application, wherein said application adapted to manage one or more plug-ins and to inject one or more of said plug-ins into a webpage currently being displayed.

In yet another aspect, the present invention relates to a system for broadcasting browsing sessions, comprising:
a) at least one processor; and
b) a memory comprising computer-readable instructions which when executed by the at least one processor causes the processor to execute plug-ins for a web browser (for recording, playing or editing browsing sessions), wherein the recording plug-ins:
   i. records of browsing actions;
   ii. saves actions created by said plug-in as a unique recorded session in a database;
      wherein the editing plug-in:
   iii. enables to add layers of content either during or after the recording of a browsing session; and
      wherein the playing plug-in:
   iv. activates said stored unique recorded session by fetching and executing said stored browsing actions; and
   v. adds layers of content to the playing browsing session, as long as such layers were added (e.g., by the creator of the recorded browsing session during recoding or editing of the browsing session).

In a further aspect, the present invention relates to a non-transitory computer-readable medium comprising instructions which when executed by at least one processor causes the processor to perform the method of the present invention.

### BRIEF DESCRIPTION OF THE DRAWINGS

In the drawings:

FIG. 1 is a flow chart generally illustrating an embodiment of the invention;

FIG. 2 schematically illustrates a suitable computing environment in which embodiments of the invention may be implemented;

FIG. 3 is a flow chart generally illustrating the method of playing a web browsing session;

FIG. 4 is a flow chart generally illustrating the method of recording a web browsing session; and

FIG. 5 schematically illustrates an implementation of an affiliate model using the system of the present invention.

### DETAILED DESCRIPTION OF THE INVENTION

Reference will now be made to several embodiments of the present invention, examples of which are illustrated in the accompanying figures. Wherever practicable similar or like reference numbers may be used in the figures and may indicate similar or like functionality. The figures depict embodiments of the present invention for purposes of illustration only. One skilled in the art will readily recognize from the following description that alternative embodiments of the structures and methods illustrated herein may be employed without departing from the principles of the invention described herein.

Embodiments of the invention provide computer-implemented system and method for streaming browsing activity and information, including web browser sessions between computer systems (i.e., broadcasting browsing sessions). One method includes recording of browsing stream as actions that are performed by an input device (e.g., computer mouse, keyboard, touchscreen, etc.), editing the stream, adding layers of content that are not part of the original website content (for example, textual/visual/audible annotation, subtitles, soundtrack, marks, emoticons etc.) and displaying the stream either live or on demand by executing or restoring the recorded actions stream on a viewer's web browser. As the system records the actual actions (e.g., scrolling a webpage to one or more specific line/region, moving a pointer from one coordinate to another on the webpage, clicking on a clickable element that appears in the webpage or on the web browser that display the webpage, typing a URL address, controlling media players etc.) that are performed during a browsing session, the recorded actions can be recreated or reproduced (e.g., after being edited with additional content) on other systems regardless the hardware, the Operating System (OS) and the type of web browser that is used. For example, a browsing session recorded on a PC with Microsoft Windows OS while using the Google Chrome web browser can be reproduced seamlessly on Apple's Mac OS using the Safari web browser by Apple Inc.

Embodiments of the invention include systems and non-tangible computer-readable media storing computer program code to cause implementation of the methods discussed herein. Many additional features and functionalities of certain embodiments of the invention will be described in more detail herein or will be appreciated from the practice of the various embodiments of the invention.

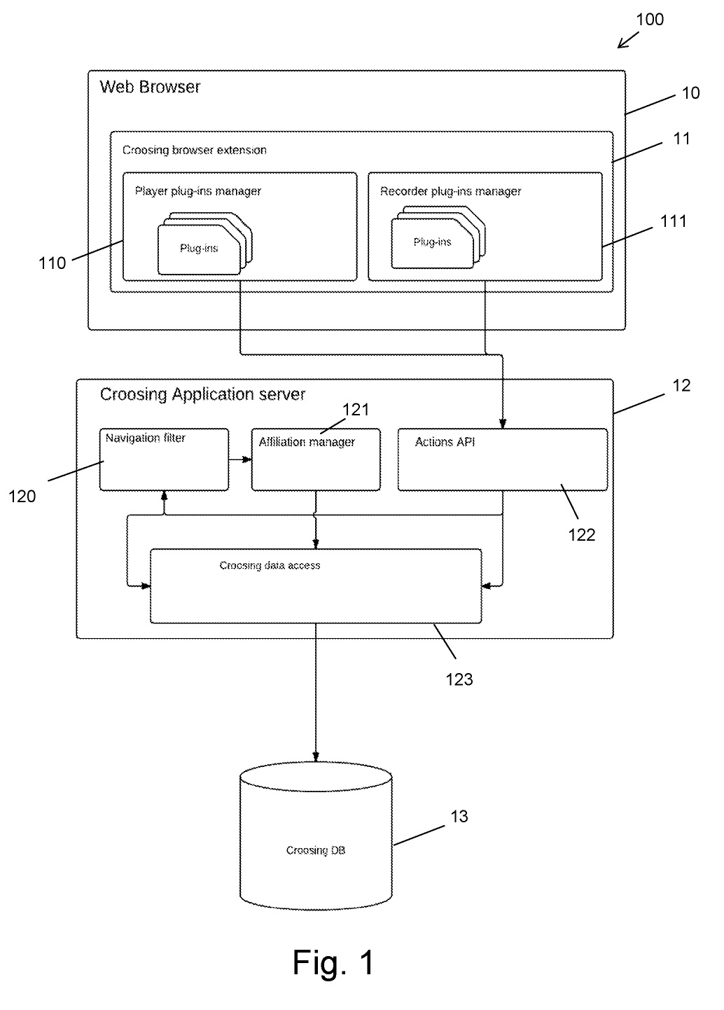

FIG. 1 schematically illustrates a system 100 for broadcasting browsing sessions, according to an embodiment of the invention. System 100 comprises a web browser 10, a web browser extension 11, an application server 12, and a database 13. As will be appreciated by a person skilled in the art, in some embodiments, the functionality of web browser extension 11 can be an integral part of web browser 10.

Web browser extension 11 extends the functionality of a given web browser program, such as web browser 10, that runs on a terminal device (such as a personal computer, smartphone, smart TV etc.) and that is used for navigating between webpages and websites, by providing a player plug-ins manager 110 and a recorder plug-ins manager 111 as will be described in further details hereinafter. To minimize the need to download and/or install programs on users' computers and as many currently-available web browser programs permit the installation of additional features, such as through what are commonly known as “browser extensions”, certain embodiments of the invention utilize existing web browser technology. Many web browser programs currently exist or are under development, and it would be impossible to name all such browser programs, but examples of such programs include Microsoft's Internet Explorer, Microsoft Edge, Mozilla Firefox, Google Chrome, Apple Safari, Opera Software's Opera browser, as well as browsers specifically configured for specific devices, such as Internet-connected smart phones and the like.

For web browsers that do not currently support browser extensions, other mechanisms and installed programs are often available to provide similar functionality. For example, a stand-alone application may work in conjunction with the browser to provide functionality to the browser program. In some systems, smart phones and other mobile devices being examples, a program commonly called an app may provide specific functionality tailored to specific devices. Programs such as these may provide functionality discussed herein as being provided by a browser extension.

Embodiments of the invention utilize a web browser extension or similar format to provide information sharing, and particularly session streaming between remote computers by enabling to record, edit and play web browsing actions, so as to enable a web browser program on one computer to automatically “follow” or “mimic” actions of browsing session performed by one or more input devices on a web browser program on another computer (i.e., view/play a web-browsing session by reproducing the input devices actions performed on each visited webpage during this session). In this way, embodiments of the invention provide streams of information between computers at very low amounts of bandwidth, as the system only records data that represents the action that specify a position in space of a webpage (e.g., such scrolling to a specific image location in a webpage), as will be discussed in more details herein below. In many instances, the installation of the browser extension occurs essentially without the computer's operating system being made aware of any additional installation. Instead, the web browser program itself handles the browser extension and any demands made by the browser extension. A browser extension in accordance with embodiments of the invention, for example, may be rapidly and easily installed, such as by visiting a download website.

Once the functionality or features of the browser extension has been installed or added to the web browser, the web browser and the browser extension may be used to allow one user's browser to play streams of information recorded by another remote user's browser, with very minimal network traffic passing to and from the two users' computers and with many benefits over existing systems, some of which will be described below. While the specific functionality of the browser extension may be varied in essentially infinite ways while maintaining the functionality that will be discussed herein, including customizations for each user to facilitate each user's access, a description of ways in which that functionality may be provided is given below.

According to an embodiment of the invention, the streaming of online information may involve the following components:
A dedicated website—displays at least abstract of the content of each browsing session as an index, and allows the users to conduct a search for content and manage their personal profile. The website may help a user to discover content matching his personal preferences or profile, using channels, internal search engine, personal recommendations etc. Alternatively, users may play/view a recorded browsing session directly by clicking a link without passing thru the website;
Web browser extension—uses the ability of the browser extension to inject scripts to a webpage being displayed (e.g., such as an HTML based webpage or other technology used to create visually engaging web pages) and to keep a state while navigating between webpages and websites by using background functionality;
Application Server—exposes services to the browser extension and may handle business logics;
Database—stores data such as browsing session information that may include URL address of visited webpages actions applied by input devices in each visited webpage, users, analytics, etc.;

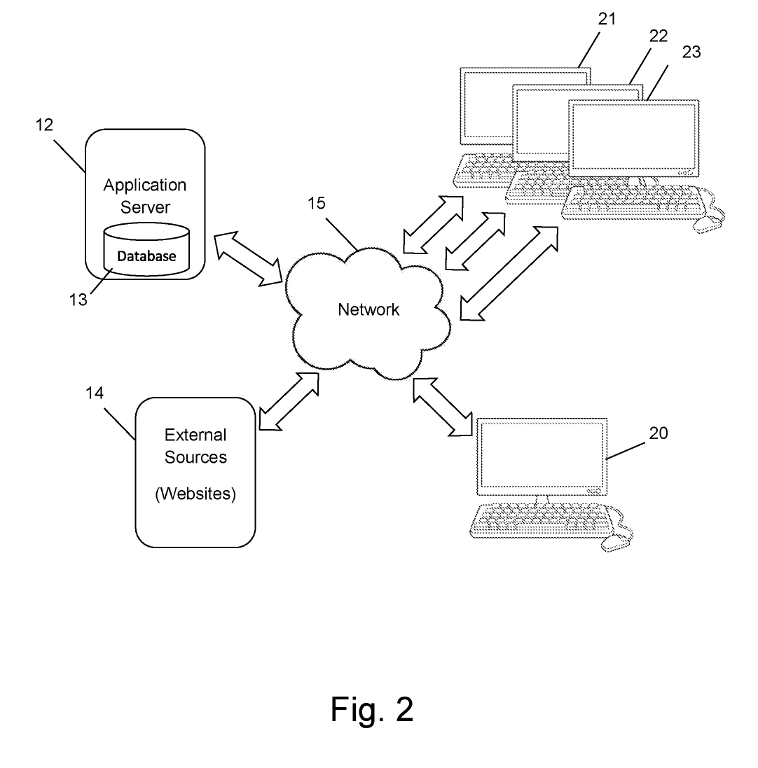

FIG. 2 and the corresponding discussion are intended to provide a general description of a suitable computing environment in which embodiments of the invention may be implemented. One skilled in the art will appreciate that embodiments of the invention may be practiced by one or more computing devices and in a variety of system configurations, including in a networked configuration. However, while the methods and processes of the present invention have proven to be particularly useful in association with a system comprising a general purpose computer that is suitable to run a web browser, embodiments of the present invention include utilization of the methods and processes in a variety of environments and operating systems that may run web browsers at variety of display resolutions, including embedded systems with general purpose processing units, digital/media signal processors (DSP/MSP), application specific integrated circuits (ASIC), standalone electronic devices, and other such electronic environments that are suitable to run a web browser.

Embodiments of the present invention embrace one or more computer-readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer-readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), Flash memory or any other device or component that is capable of providing data or executable instructions that may be accessed by a processing system. While embodiments of the invention embrace the use of all types of computer-readable media, certain embodiments as recited in the claims may be limited to the use of tangible, non-transitory computer-readable media, and the phrases “tangible computer-readable medium” and “non-transitory computer-readable medium” (or plural variations) used herein are intended to exclude transitory propagating signals per se.

The terminal device, on which the web browser program resides, may be a general-purpose or special-purpose computer or any of a variety of consumer electronic devices. For example, terminal device may be a personal computer, a notebook computer, a netbook, a personal digital assistant (“PDA”) or other hand-held device, a tablet, a phablet, a smart phone, a smart TV or the like. The terminal device includes at least one input device (i.e., a piece of computer hardware equipment used to provide data and control signals to the terminal device), such as a keyboard, a computer mouse, a touchscreen, voice recognition etc.

Thus, while those skilled in the art will appreciate that embodiments of the present invention may be practiced in a variety of different environments with many types of system configurations, FIG. 2 provides a representative networked system configuration that may be used in association with embodiments of the present invention. The representative system of FIG. 2 includes a terminal device equipped with a web browser that includes the functionality of the web browser extension of the present invention, illustrated as a client 20, which is connected to one or more other terminal devices that are also equipped with a web browser that includes the functionality of the web browser extension (illustrated as clients 21, client 22 and client 23), an external source 14 and to application server 12, across network 15. While FIG. 2 illustrates an embodiment that includes a client 20, three additional clients, clients 21-23, one external source 14 (e.g., a web server that hosts one or more website, wherein each website includes a set of related webpages served from a single web domain), and application server 12, connected to network 15, alternative embodiments include more or fewer clients (including many clients), more than one external source, and/or more than one application server 12 connected to network 15. Other embodiments of the present invention include local, networked, or peer-to-peer environments where one or more computer devices may be connected to one or more local or remote peripheral devices. Moreover, embodiments in accordance with the present invention also embrace the use of electronic consumer devices, wireless networked environments, and/or wide area networked environments, such as the Internet.

For example, after the web browser initialized all installed extensions, the web browser extension of the present invention is on standby mode, waiting for one of the following events to occur:
Start recording/editing event;
Start playing event;

In this embodiment, each event has a plug-ins manager (as indicated by numerals 110 and 111 in FIG. 1) that responsible to load the appropriate plug-ins in order to provide the needed functionality and to receive a save request from the plug-ins. Once the plug-ins manager receives a save request, he calls an Application Programming Interface (API) (e.g., an action API is indicated by numeral 122 in FIG. 1) at the application server 12 for saving data representing the action performed by the input device at the web browser. The application server 12 may store the data that represents the action in a database associated with server 12 such as database 13. For example, each plug-in is registered to one or more Document Object Model (DOM) and web browser events and can inject software code in a language used to create webpages such as HyperText Markup Language (HTML) and Java Script (JS) to the displayed webpage. According to some embodiments, the system of the present invention allows external developers to add plug-ins of their own for each type of event thus enhancing the functionality.

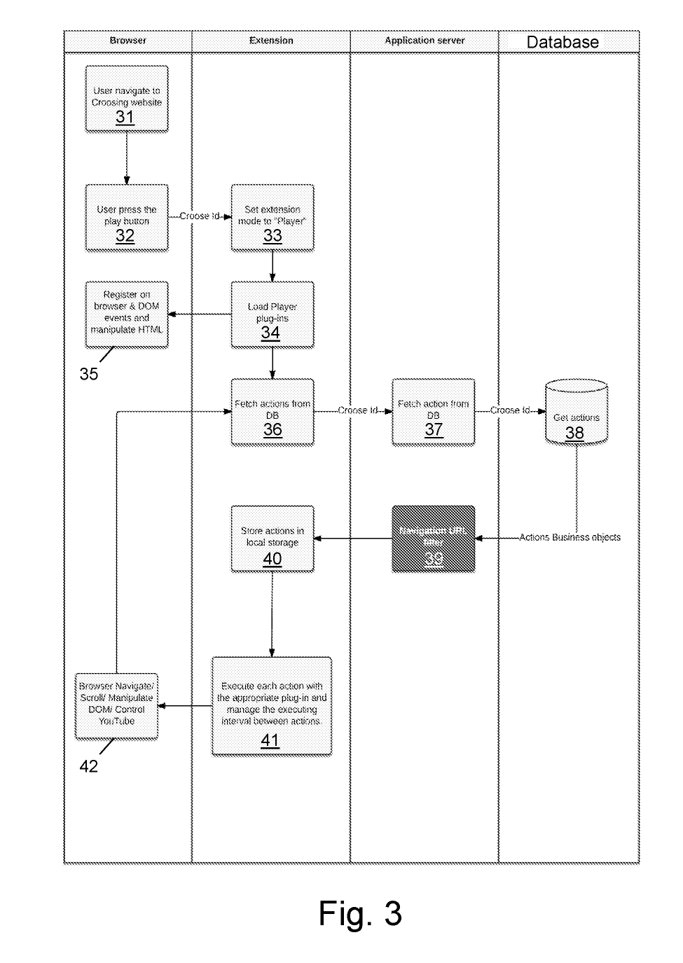

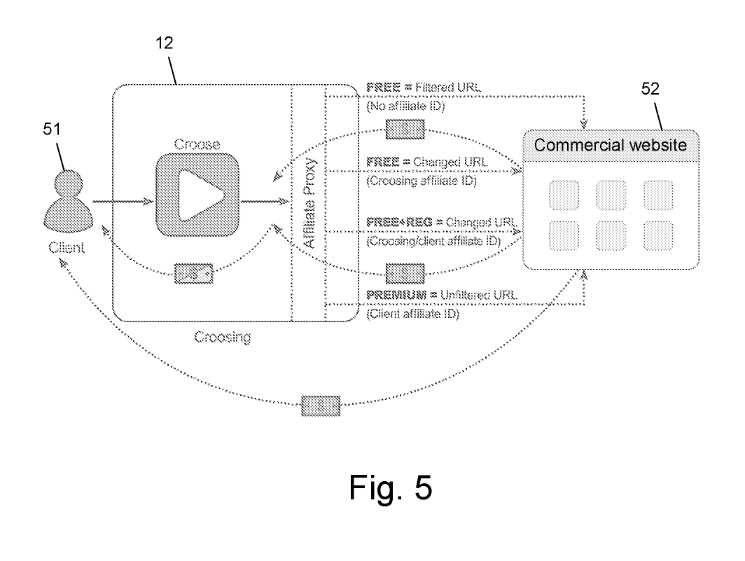

FIG. 3 conceptually illustrates how the web browser extension of the present invention may be used to enable one or more viewers to enjoy an online voyage through their web browsers by enabling the web browser to reproduce the actions performed during a browsing session of a specific user by executing one or more playing events that were recorded during the browsing session of the specific user. FIG. 3 depicts actions that may occur at or distribute across the following system's components: the web browser, the web browser extension, the application server, and the database. Establishing a playing event may involve the following procedures:
Using the web browser, a user may navigate to the dedicated website (block 31) that may display the available recoded content of different browsing sessions as an index, and thereby allowing searching and managing content;
waiting for the user to activate a playing event (block 32), e.g., a playing event may be activated by pressing on a corresponding “play” button that may appear at the webpage of the dedicated website, or a user may directly activate a playing event by using a direct URL link. The user may receive a direct URL via any communication channel, such as by clicking a URL link that may appear in an electronic message (e.g., social post, direct message, email, etc.), or the user may provide the a direct URL manually (e.g., by typing or pasting);
providing a browsing session identification (ID) of the activated playing event to the web browser extension and setting the web browser extension to a “player” mode (step 33);
loading plug-ins of the player mode (step 34). Examples of some possible plug-ins of the “player” mode are shown in Table 1 herein below;
registering on the web browser and DOM events and manipulating webpages associated with the browsing session (e.g., by injecting HTML code to the webpages) (step 35);
fetching actions (i.e., input device actions performed by a specific user during a browsing session) stored in the database using the browsing session ID via the application server (steps 36-37);
getting stored actions from the database (step 38);
optionally, applying URL navigation filter for action business objects (step 39). A URL navigation filter 120 and an affiliation manager 121 can be part of server 12 as shown in FIG. 1 and as will be described in further details hereinafter with respect to an implementation of an affiliate model shown in FIG. 5;
storing the actions received from the database in a local storage, e.g., at client 21 of FIG. 2 (step 40); and
executing each action with the appropriate plug-in and managing the executing intervals between the actions (step 41), thereby allowing browser navigating/scrolling/manipulating DOM/controlling media players, etc. (step 41).

### Play Plug-in Manager

Responsible for the loading, executing and timing of each reproduced action by the appropriate plug-in and injects player toolbar (play, stop, etc.) as an HTML and JS to the currently displayed HTML page.

Following is an example list of system's plug-ins for the player mode:

TABLE 1

| Plug-in | Description |
|---|---|
| Navigator | Gets a navigate action and navigates to a |
| | specific page. |
| Scroller | Gets a scroll action, makes some screen |
| | resolution adjustments and scrolls to the |
| | calculated position. A jQuery (JavaScript |
| | library) can be used to calculate the |
| | scrolling position. |
| Captions | Gets a caption action, removes the previous |
| | caption if exists, and injects a caption |
| | HTML to the currently displayed webpage. |
| SoundTracker | Responsible for playing a soundtrack alongside |
| | the played browsing session using an external |
| | music service such as “SoundCloud” - |
| | keeping the soundtrack fluent during webpages' |
| | loading. |
| AJAXRequestHandler | Executes an http get/post AJAX request at |
| | websites that utilizes AJAX for more complex |
| | actions (forms, search, controllers etc.). |
| YouTube | Gets a “YouTube” action (such as play, |
| | stop, etc.) and invokes the YouTube player |
| | events by injecting JS to the currently |
| | displayed “YouTube” webpage. |

In most instances, the viewers of a recorded browsing session will not have multiple concurrent play sessions active, although it is possible to do so, for example, if different browsers and different session identifiers are used. Alternatively, a browser extension may be provided that supports multiple different sessions within a single browser (e.g. one session per browser tab).

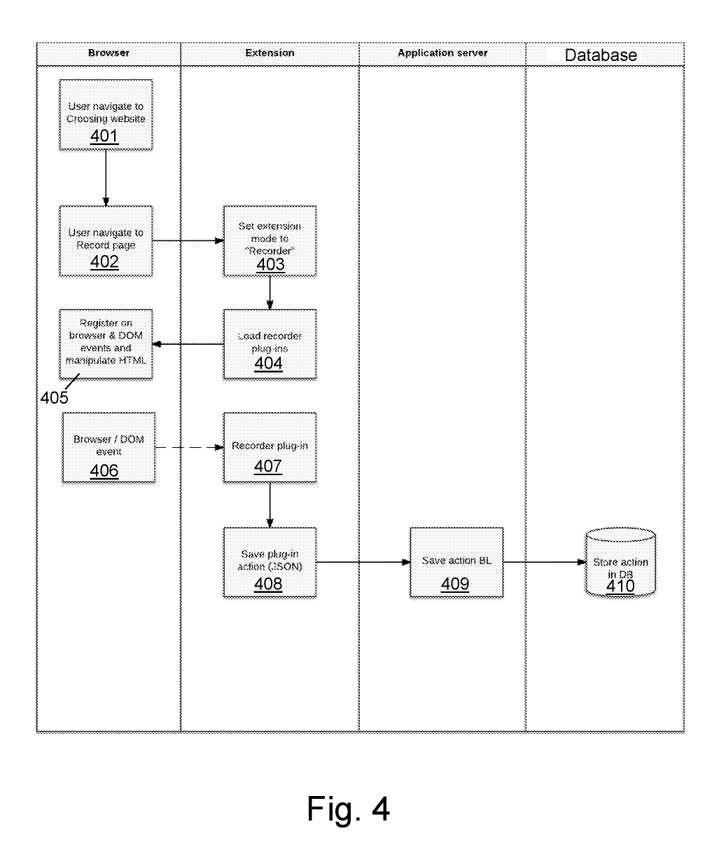

On executing a recoding event, the steps are largely similar. FIG. 4 conceptually illustrates the method of recording a web browsing session, according to an embodiment of the invention. In this embodiment, execution may begin with installation of the browser extension (if not previously installed), and may proceed as follows:
navigating to the system's dedicated website (step 401);
navigating to a record page at the system's dedicated website (step 402);
setting the web browser extension to a “record” mode (step 403);
loading plug-ins of record mode (step 403). Examples for plug-ins of the “record” mode are shown in Table 2 herein below;
registering on web browser and DOM events and manipulating HTML (step 405);
for each web browser/DOM event (step 406), applying the relevant recorder plug-in (step 407);
saving plug-in actions at the web browser extension, e.g., using JavaScript Object Notation (JSON) file (step 408);
saving actions at the application server (step 409); and
storing action in the database (step 410).

The user accesses the system's dedicated website (step 401) and selects to record a browsing session (step 402). Optionally, the user may register/identify himself/herself to the browser extension, at step 401, largely to permit the application server to associate the recorded session with the user. This step may be optional in certain situations, as it may be desirable to permit anonymous recording sessions in some circumstances. Alternatively, this step may be optional if the user is already identified by the browser extension.

While it may be optional for the user to be identified by the browser extension (and correspondingly by the application server), it is necessary for the user to provide some sort of identification of the session to be recorded. For example, the user may provide such identifying information at step 402.

### Record/Edit Plug-in Manager

As aforementioned herein above the record plug-in manager is responsible for loading of the recording plug-ins and saving the actions created by each plug-in that reflects the user's activity during the browsing session (e.g., scrolling, navigating, clicking on clickable object in a webpage such as a link, playing a video clip, controlling media players etc.), as well as for injecting the recorder/editor toolbar HTML and JS. The record/edit plug-in manager may also allow editing the recorded session by adding variety of layers to the original recorded browsing event during the recording session (i.e., in real-time time while recording) or at any time after completing the recorded browsing session. An editing toolbar can be provided which may further allow adding, cutting or changing actions and added layers in previously recorded browsing sessions. The added layer can be soundtracks (e.g., voice instructions, speech, music, etc.), captions, marks, emoticons or any other data which can be used to enrich the original recorded event. The plug-in itself can be provided in form of a layer or a “floating” menu that may appear as part of the browser on top of each displayed webpage.

Following is an exemplary list of system's plug-ins for the record mode:

TABLE 2

| Plug-In | Description |
|---|---|
| Navigator | Catches navigations made while |
| | recording, creates navigation action and |
| | calls the plug-in manager in order to save it. |
| Scroller | Catches every scroll made while |
| | recording, creates scroll action and calls |
| | the plug-in manager in order to save it. |
| Caption | Injects an “Add Caption” button to a |
| | recorder toolbar, registers on button |
| | pressed event, injects the create caption |
| | HTML to the currently displayed |
| | webpage, creates the caption action and |
| | calls the plug-ins manager in order to |
| | save it. |
| SoundTrack | Injects an “Add soundtrack” button to the |
| | recorder toolbar, injects the select sound |
| | track HTML to the currently displayed |
| | webpage, injects a “Stop soundtrack” to |
| | the recorder toolbar, creates add/stop |
| | soundtrack actions and calls the plug-ins |
| | manager in order to save the actions. |
| AjaxRequestHandler | Catches every ajax http get/post request, |
| | creates the appropriate action and calls |
| | the plug-ins manager in order to save it. |
| YouTube | When entering a web page with |
| | “YouTube” player, the plug-in registered |
| | to the player events (using a player API), |
| | creates action each time event is raised |
| | and calls the plug-in manager in order to |
| | save it. |

According to an embodiment of the invention, the establishing of a playing or record event session does not involve sending massive amounts of information regarding what is displayed on the user's monitor or other viewing screen to each user. Moreover, the data generated during the recorded actions may be optimized in order to reduce the amount of the generated data, by using only part of the generated data in order to define an action performed with an input device. For example, data generated by an input device during a scrolling action from one location to another can be reduced to data representing the starting location and the ending location of the scrolling action. Additionally, the establishing of a session does not require reformatting or resizing of the users' display resolution. If any initial information is sent, it may be limited to simply forwarding a URL of the website to which the recorder's browser is currently (or was) pointed plus any additional action conveyed to provide additional following functions (e.g. location within the displayed webpage to move to, location of the pointing device within the page, etc.) to all activated players as they connect to the player session.

It should be noted that the steps of establishing a play or record session as discussed above may occur essentially simultaneously or they may be separated in time by any desired amount.

Either the record or play event of a browsing session can be paused, stopped or exit at any time. Thus, the browser extension may provide a “stop” button or the like to permit exiting the current session. Alternatively, the user may simply shut down the browser through which the session is provided and with which the browser extension is associated.

Additional advantage of the present invention, is that during a play event of a browsing session, the user can take personal actions on the different websites through which the play session navigates him or her, as the system actually reproduce the browsing actions (i.e., automatically performs action on the user browser).

The foregoing examples are simply examples of possible features that could be incorporated into versions and embodiments of the invention. Not every feature need be incorporated or available in every version and embodiment of the invention. Additionally, it should be apparent that other features other than those specifically discussed above may be made available with certain embodiments of the invention and still fall within the scope and embrace of implementation of the invention. Embodiments of the invention may be utilized for a variety of applications of varying complexity. For example, embodiments of the invention may be readily used between friends, between marketing specialists and potential consumers, between opinion leaders and their followers or by support personnel to direct users to a particular website or to show a demonstration.

It should be recognized that embodiments of the invention may include an optional password or other authorization step to ensure that only authorized users are permitted to play a specific recorded event. Thus, a user activating a specific play event could be presented with a challenge to enter a password associated with the event. If the password is properly entered, the activation of the play event would be granted. If not, the user could be prompted to reenter the correct password or the activation of that event could be denied. It should be recognized that embodiments of the invention may include an optional password or other authorization step to ensure that only authorized user are permitted to activate a specific play event.

While much of the foregoing discussion has incorporated the use of a browser extension as an example, it should be understood that the use of a browser extension was an example only, and not by way of limitation. Similar functionality may be provided by various applications and apps on different platforms. For example, such functionality may be directly incorporated into a browser program instead of as a browser extension. On a mobile device such as a smart phone or tablet computer, such functionality may be provided as an app that may operate separately from or in conjunction with any browser installed on the smart phone. The functionality may be provided by a separate application on essentially any computer system as well as any device providing a browser or browsing capabilities similar to a browser program. For example, browser programs are now being provided on some televisions and other electronic devices that have not traditionally had browsing capabilities. Other devices may be specifically designed primarily as browsing devices and may not provide many other common computer functions. Regardless of how the functionality is provided on each particular system or device, similar functionality may be provided. In this way, embodiments of the invention may provide communications across platforms in ways not possible with other systems and without requiring a major installation on such systems. Additionally, essentially the same interface may be provided on any device, making using embodiments of the invention on various devices a seamless and easy transition.

Turning now to the implementation of novel affiliate models using the embodiments described hereinabove is shown in FIG. 5. As aforementioned hereinabove and shown in FIG. 1, server 12 may include affiliation manager 121 and URL navigation filter 120.

An affiliate model may be managed by applying the URL navigation filter 120 to filter an affiliate ID of a user 51, if exist as part of a URL address. Optionally, enabling to replace the filtered affiliated ID with an alternative affiliate ID, thereby enabling an entity associated with the alternative affiliate ID to be credited when users that play a recorded session enter selected websites during that session (e.g., when entering commercial websites as indicated by numeral 52). Alternatively, the filtered affiliated ID may also be credited by the affiliation manager 121.

All the above will be better understood through the following illustrative and non-limitative examples:

1. When a user is not registered as a “commercial user” and tries to lead a recorded session using his personal affiliate ID into different websites, his ID will be filtered—erased or replaced.
2. If the system recognizes that a user is leading a recorded session into websites that have an affiliate agreement, it will automatically add the corresponding affiliate ID (e.g., as part of the URL address).
3. Users that are registered as “commercial user” enjoy a share of the revenue received from website with affiliate agreement.
4. Users that are registered as “premium user” can manage their own affiliate agreements and enjoy the whole revenue.

All the above description and examples have been given for the purpose of illustration and are not intended to limit the invention in any way. The features and uses of embodiments of the invention discussed herein are merely illustrative of the advantages and uses of embodiments of the invention, and are not limited to the specifics provided herein. The scope of the invention is not limited by the specifically-illustrated examples, but is to be determined from the appended claims.

1. A computer-implemented method for editing a browsing session, comprising the steps of:
a) fetching, from a database, data relative to actions applied by at least one input device during recording of an original browsing session; and
b) adding at least one layer of content to the original browsing session either during the recording of the browsing session or after completing the recording of the browsing session, by injecting scripts to a webpage being displayed, thereby enabling to change or to enrich the content of the original recorded browsing session, thus said browsing session can be displayed, either live or on demand, by executing or restoring the recorded actions on a viewer's web browser.

2. A method according to claim 1, wherein the editing further comprises adding, cutting or changing actions and added content layers in recorded browsing sessions.

3. A method according to claim 1, wherein the added at least one layer is selected from the group consisting of audible data, textual data, symbols, captions, marks, emoticons or combination thereof.

4. A method according to claim 1, wherein the editing is done by an extension installed or added to a web browser, wherein said extension is adapted to manage one or more plug-ins and to inject one or more of said plug-ins into a webpage currently being displayed.

5. A system for editing a browsing sessions, comprising:
a) at least one processor; and
b) a memory comprising computer-readable instructions which when executed by the at least one processor causes the processor to execute web browser's plug-ins for editing a recorded browsing session, wherein the plug-in:
i. fetches data relative to actions applied by at least one input device during recording of an original browsing session in correspondence with one or more visited webpages; and
ii. adds at least one layer of content to the original browsing session either during the recording of the browsing session or after completing the recording of the browsing session, by injecting scripts to a webpage being displayed, thereby enabling to change or to enrich the content of the original recorded browsing session, thus said browsing session can be displayed, either live or on demand, by executing or restoring the recorded actions on a viewer's web browser.

6. A non-transitory computer-readable medium comprising instructions which when executed by at least one processor causes the processor to perform the method of claim 1.
